(19) United States
(12) Patent Application Publication
(10) Pub. No.: US 2015/0293652 A1
(43) Pub. Date: Oct. 15, 2015

(54) CREATING AN INTERACTION AREA FOR LISTING USER-SELECTABLE ITEMS

(71) Applicant: International Business Machines Corporation, Armonk, NY (US)

(72) Inventor: Shin Saito, Tokyo (JP)

(21) Appl. No.: 14/748,588

(22) Filed: Jun. 24, 2015

Related U.S. Application Data
(63) Continuation of application No. 14/657,508, filed on Mar. 13, 2015.

(30) Foreign Application Priority Data
Mar. 31, 2014 (JP) 2014-071953

(51) Int. Cl. G06F 3/0482; G06F 3/0484

(52) U.S. Cl. CPC G06F 3/0482; G06F 3/04847

(57) ABSTRACT

A computer implemented method for creating an interaction area that lists a plurality of user-selectable items includes creating, by the computer, drawing data of the interaction area such that each of neighboring items which are at least some items among the plurality of items partially protrudes into an area of the other item; and outputting, by the computer, the created drawing data of the interaction area.

### DOMESTIC AND FOREIGN PRIORITY

This application is a continuation of U.S. patent application Ser. No. 14/657,508, filed Mar. 13, 2015, which claims priority to Japanese Patent Application No. 2014-071953, filed Mar. 31, 2014, and all the benefits accruing therefrom under 35 U.S.C. §119, the contents of which in its entirety are herein incorporated by reference.

### BACKGROUND

Embodiments of the present invention relates to a technique for creating an input field that lists a plurality of user-selectable items, such as a list box, and more particularly to an interaction area creation technique suitable for screen display for a display equipped with a touch interface.

Recently, the screen resolution of mobile and tablet terminals that include a display equipped with a touch interface has become higher and higher. When a lot of information is displayed on the screen in such a circumstance, the sizes of widgets such as a list box and a menu inevitably become smaller. Particularly, in an interaction area that lists a plurality of user-selectable items, such as a list box, each of strip-shaped items gets thinner. The resulting shape no longer fits with the nearly circular shape of the touch point of a finger, making the operation more difficult. This is also confirmed by Fitts's law.

Fitts's law is a law indicating that the time taken to complete an operation for moving a pointer from a point A to a target object B illustrated in FIG. 3 (deemed difficulty) can be expressed by a function of (distance D from the point A to the target object B)/(depth S of the target object B in the moving direction). This law holds true for a wide variety of UIs. Because each item listed in a list box is horizontally long (that is, S is much smaller than D), it can be concluded that the operation is difficult.

Examples of the related art for preventing operation mistakes on a touchscreen include Patent Literatures 1 to 3 and Non-patent Literature 1.

JP2007-102442 (Patent Literature 1) discloses a touchscreen device including a display monitor, a touchscreen provided on the screen of the display monitor, frequency detection means, enlarged display start time calculation means, and touch area control means. On the display monitor, a plurality of buttons whose input contents are displayed using characters, figures, or the like, or a menu including a plurality of items is displayed. In response to pressing of a touch area set for a corresponding button or menu item, the touchscreen outputs a corresponding press signal. The frequency detection means detects a highly frequently pressed button or menu item from among the buttons or menu items. The enlarged display start time calculation means calculates the time taken from when a highly frequently pressed button or menu item is displayed to when enlarged display of the button or menu item is started. The touch area control means enlarges a touch area of a button or menu that is determined to be pressed highly frequently when the enlarged display start time passes from displaying of the button or menu item.

JP2008-77272 (Patent Literature 2) discloses a touchscreen control device configured to display option buttons on a display screen and identify a pressed option button by detecting the coordinates at which a touchscreen provided on the display screen is touched with a finger. When the touchscreen is touched with a finger while a plurality of option buttons are being displayed on the display screen, option buttons in the vicinity of the touched coordinates are rearranged and enlarged such that these option buttons are displayed across the entire screen. Thereafter, when the touchscreen is touched with a finger again, it is determined that an option button at the touched coordinates is pressed.

JP2010-113441 (Patent Literature 3) discloses an image display device including a display panel, a touchscreen, and a display control unit. The display control unit performs control such that the display mode is switched between a first display mode in which a plurality of images are displayed as a list so that the images are arranged adjacent to one another, a second display mode in which an enlarged image of one image selected using the touchscreen from among the plurality of images is displayed, and a third display mode in which, in the case where the touchscreen is operated in the first display mode, a plurality of images associated with the operated position of the touchscreen are displayed less densely than in the first display mode.

Akimoto, “FishEye Tabs,” Akimoto@cybozulab.programmer.blog, Apr. 1, 1998. (Non-patent Literature 1) introduces a Mozilla Firefox (registered trademark) add-on that displays a list as a fisheye-like list if the list includes many items, and discloses a display screen of “Fisheye Menu#2” in which an item of interest is enlarged and the other items are displayed such that the items become smaller as their distance from the item of interest becomes larger.

### SUMMARY

In one embodiment, a computer implemented method for creating an interaction area that lists a plurality of user-selectable items includes creating, by the computer, drawing data of the interaction area such that each of neighboring items which are at least some items among the plurality of items partially protrudes into an area of the other item; and outputting, by the computer, the created drawing data of the interaction area.

In another embodiment, a system for creating an interaction area that lists a plurality of user-selectable items includes a processing device configured to create drawing data of the interaction area such that each of neighboring items which are at least some items among the plurality of items partially protrudes into an area of the other item; and the processing device configured to output the created drawing data of the interaction area.

In another embodiment, a non-transitory, computer readable storage medium having computer readable instructions thereon that, when executed by a computer, implement a method for creating an interaction area that lists a plurality of user-selectable items. The method includes creating, by the computer, drawing data of the interaction area such that each of neighboring items which are at least some items among the plurality of items partially protrudes into an area of the other item; and outputting, by the computer, the created drawing data of the interaction area.

### BRIEF DESCRIPTION OF THE DRAWINGS

FIG. 1 illustrates an example of a hardware configuration of a computer 100 which implements a system for creating an interaction area that lists a plurality of user-selectable items in accordance with an embodiment of the present invention.

FIG. 2 illustrates an example of a software configuration of the computer 100.

FIG. 3 is a diagram describing the overview of Fitts's law.

FIG. 4A illustrates an example of a list box according to the related art that is displayed on the screen.

FIG. 4B illustrates an example of a list box according to embodiments of the present invention that is displayed on the screen.

FIG. 4C illustrates another example of the list box according to embodiments of the present invention that is displayed on the screen.

FIG. 4D illustrates another example of the list box according to embodiments of the present invention that is displayed on the screen.

FIG. 5 is a diagram describing symbols used for items herein.

FIG. 6 is a diagram describing a label display area of each item.

FIG. 7 is a functional block diagram of the system for creating an interaction area that lists a plurality of user-selectable items in accordance with the embodiment of the present invention.

FIG. 8 is a flowchart illustrating a flow of an array-of-merge-units determining process.

FIG. 9 is a flowchart illustrating an example of a flow of a process for creating an interaction area that lists a plurality of user-selectable items in accordance with the embodiment of the present invention.

FIG. 10A illustrates a modification of the list box according to embodiments of the present invention that is displayed on the screen.

FIG. 10B illustrates another modification of the list box according to embodiments of the present invention that is displayed on the screen.

FIG. 10C illustrates another modification of the list box according to embodiments of the present invention that is displayed on the screen.

FIG. 10D illustrates another modification of the list box according to embodiments of the present invention that is displayed on the screen.

FIG. 11A illustrates an example of an indicator displayed along with the list box according to embodiments of the present invention.

FIG. 11B illustrates an example of an indicator displayed along with the list box according to embodiments of the present invention.

FIG. 12A illustrates an example of a table according to embodiments of the present invention that is displayed on the screen.

FIG. 12B illustrates an example of a combo box according to embodiments of the present invention that is displayed on the screen.

### DETAILED DESCRIPTION

The techniques disclosed by Patent Literatures 1 to 3 and Non-patent Literature 1 prevent operation mistakes by performing enlarged display, less dense display, and further by enlarging a touch area of a highly frequently pressed button. However, these techniques may also cause a high degree of dissatisfaction when unintended items are subjected to processing such as enlargement. Also, because an item of interest that is enlarged dynamically changes with the technique disclosed by Non-patent Literature 1, such a technique gives a viewer an impression of being unnatural and uncomfortable.

Embodiments of the present invention are disclosed in view of the above-described problems of the related art, which provide a method, system, and program product for creating an interaction area that lists a plurality of user-selectable items, which are capable of improving the operability when an item is selected.

To solve the above-described problems of the related art, embodiments of the present invention provide a method for creating an interaction area that lists a plurality of user-selectable items, the method being implemented by a computer and having the following features. The method according to embodiments of the present invention includes creating, by the computer, drawing data of the interaction area such that each of neighboring items which are at least some items among the plurality of items partially protrudes into an area of the other item; and outputting, by the computer, the created drawing data of the interaction area. Here, the plurality of items may be arranged vertically in the interaction area and each item may be horizontally long. Alternatively, the plurality of items may be arranged horizontally in the interaction area and each item may be vertically long.

Preferably, the number of neighboring items is determined as a merge unit from among a plurality of candidates.

More preferably, a combination of the merge units for all the items in the interaction area is determined by solving a cost minimization problem where a length of the parts of labels of items hidden by protruding parts of neighboring items is associated with cost in dynamic programming and the merge unit is associated with an option in dynamic programming.

Further, more preferably, the plurality of candidates includes 1, and in a case where 1 is selected as the merge unit, a value serving as a penalty is added to the cost.

Also, more preferably, in a case where a predetermined number of different candidates or more are selected as the merge unit from among the plurality of candidates, a value serving as a penalty is added to the cost.

Also, preferably, on condition that the plurality of candidates includes no value selectable as the merge unit, a value smaller than the plurality of candidates is selected.

A plurality of values may be adopted as the number of neighboring items for the interaction area.

The interaction area may be a list box, a combo box, or a table.

Also, preferably, a boundary of protruding parts of the items is formed as a curve by the computer. A background of the items listed in the interaction area is made different between the neighboring items by the computer.

Also, preferably, a background at a protruding position of each of the items listed in the interaction area is made different from a background of the other area of the item by the computer. Drawing data of an indicator which uses animation for guiding a line of sight to protruding positions of the individual items is further created by the computer, and the drawing data of the indicator is further output by the computer.

Preferably, the computer has a touchscreen. Also, preferably, the computer is a tablet computer, a notebook computer, a smartphone, or a personal digital assistant (PDA).

Embodiments of the present invention have been described above as a method for creating an interaction area that lists a plurality of user-selectable items. However, embodiments of the present invention can be considered as a program product for creating an interaction area that lists a plurality of user-selectable items, the program product causing a computer to execute each operation of such a method; and a system for creating an interaction area that lists a plurality of user-selectable items, the system being implemented by installing the program product into a computer.

In embodiments of the present invention, when an interaction area that lists a plurality of user-selectable items is created, drawing data of the interaction area is created such that each of neighboring items which are at least some of the items partially protrudes into an area of the other item. In this way, when the items are displayed, display areas of the items are expanded at the protruding positions. Thus, the user can easily select an item using the expanded area. Also, the size of the created items is kept constant unless the user gives an explicit instruction to change the size. Thus, the user interface of the interaction area does not give the user an impression of being unnatural and does not cause dissatisfaction of the user due to unintended processing, such as unintended enlarged display. Other advantages of embodiments of the present invention will be understood from the description of each embodiment.

Although an embodiment for carrying out embodiments of the present invention will be described in detail below based on the drawings, the following embodiment does not limit embodiments of the present invention defined by the claims, and not all the combinations of features described in the embodiment are mandatory to solutions provided by embodiments of the present invention. Note that the same elements are denoted by the same reference numerals throughout the description of the embodiment.

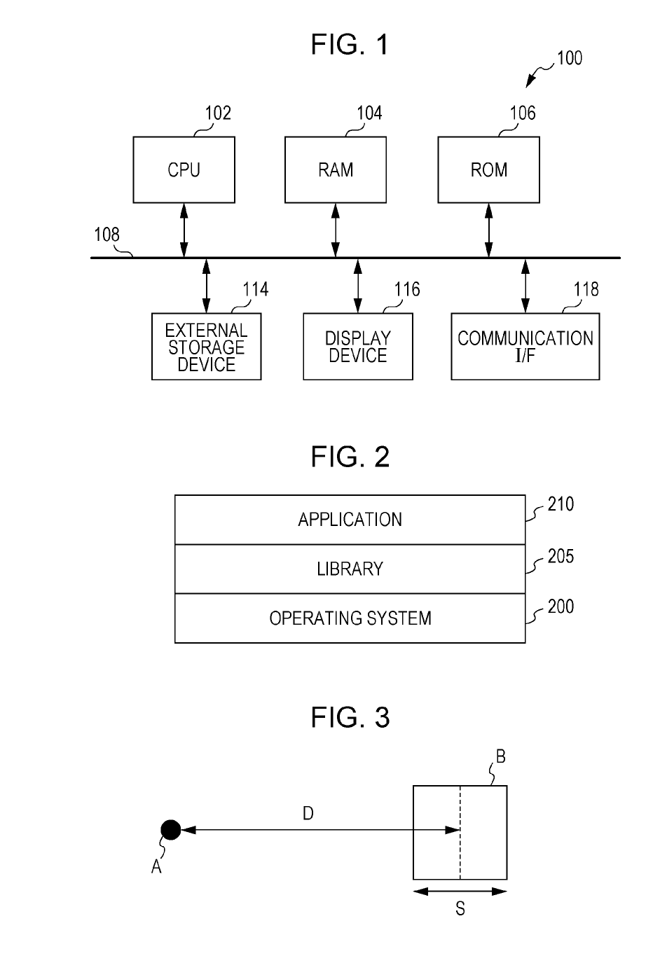

FIG. 1 illustrates an illustrative hardware configuration of a computer 100 for carrying out embodiments of the present invention. In FIG. 1, an external storage device 114 and a ROM 106 are capable of recording code of a program for creating an interaction area that lists a plurality of user-selectable items and various pieces of data for carrying out embodiments of the present invention, the program operating in cooperation with an operating system and giving instructions to a CPU 102. Each of a plurality of computer programs stored in the external storage device 114 and the ROM 106 is loaded to a RAM 104 and is executed by the CPU 102. Note that the external storage device 114 is connected to a bus 108 via a controller (not illustrated), such as a SCSI controller. Each computer program can be compressed, or can be divided into a plurality of portions and recorded on a plurality of media.

The computer 100 also includes a display device 116 that presents visual data to a user. The display device 116 is connected to the bus 108 via a graphics controller (not illustrated), and can include a touchscreen. The computer 100 is connected to a network via a communication interface (I/F) 118, and can perform communication with another computer or the like.

The above-described components are merely illustrative, and not all the components are mandatory to embodiments of the present invention. Likewise, it is obvious that the computer 100 for carrying out embodiments of the present invention can include another component, such as a speaker or an input device such as a keyboard or a mouse.

The description has been given on the assumption that the computer 100 employs a general personal computer architecture. However, a computer system of various types, for example, a desktop, laptop, or tablet personal computer, a PDA (Personal Digital Assistant), a smartphone, a digital camera, or a game system, can be employed. Also, the computer 100 may include multiple CPUs 102 or multiple HDDs to achieve higher data processing performance and availability.

Referring next to FIG. 2, an illustrative software configuration of the computer 100 for carrying out embodiments of the present invention will be described. The software configuration of the computer 100 includes an operating system (OS) 200 that provides basic functions, an application 210 that utilizes the functions provided by the OS 200, and a library 205 that is utilized by the application 210 and includes a plurality of program components that operate as part of the application 210. For example, as the OS 200, a general commercial or open-source operating system can be employed. Preferably, a function of the system for creating an interaction area that lists a plurality of user-selectable items in accordance with an embodiment of the present invention is implemented as program components (e.g., a list box, a combo box, and a table) included in the library 205. These pieces of software 200 to 210 are loaded to the RAM 104 and executed by the CPU 102 or the like. Hereinafter, program components that are included in the library 205 and implement embodiments of the present invention will be simply referred to as the library 205.

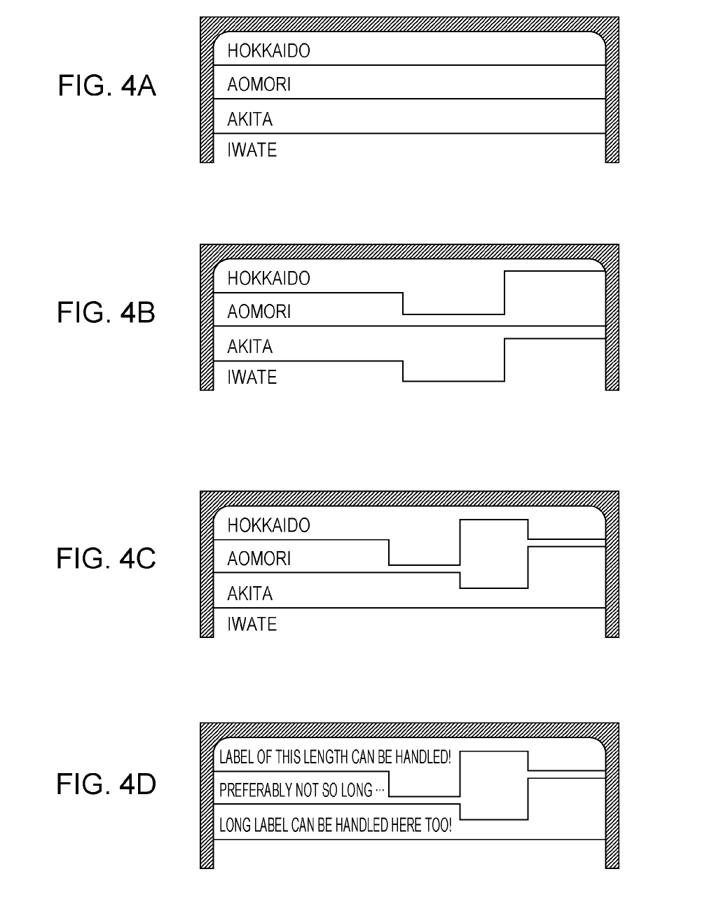

In the case where an interaction area that lists a plurality of user-selectable items, such as a list box or a combo box, is displayed, embodiments of the present invention partially expands the shape of each item when the interaction area is created, instead of dynamically changing the size of each item. In this way, embodiments of the present invention improve the operability when an item is selected. First, the overview of embodiments of the present invention will be described with reference to FIGS. 4A to 4D by using the case where embodiments of the present invention is applied to a list box, for example.

FIG. 4A illustrates a conventional list box that lists strip-shaped items vertically. As illustrated in FIG. 4A, in general, a list box that lists horizontally long items vertically often has an empty space on its right side. Accordingly, this empty space on the right side is utilized in embodiments of the present invention. Specifically, as illustrated in FIGS. 4B to 4D, an area of each item is expanded by merging the area of the item with part of a right-side area of a neighboring item. More specifically, each of a plurality of neighboring items is expanded so as to partially protrude into a horizontally long area of a neighboring item. With this configuration, a nearly circular area for a touch point of a finger can be provided at the expanded part, and thus the operability can be improved when an item is selected.

Here, the number of neighboring items whose areas are partially merged together may be any positive integer larger than or equal to 2. In the following description, the number of to-be-merged items is also referred to as a merge unit. The merge unit of the list box illustrated in FIG. 4B is 2, whereas the merge unit of the list box illustrated in FIG. 4C is 3. The merge unit need not be the same for all items of the list box. For example, a plurality of merge units may be adopted such that, in a list box made up of five rows, the first two rows are merged together and the remaining three rows are merged together.

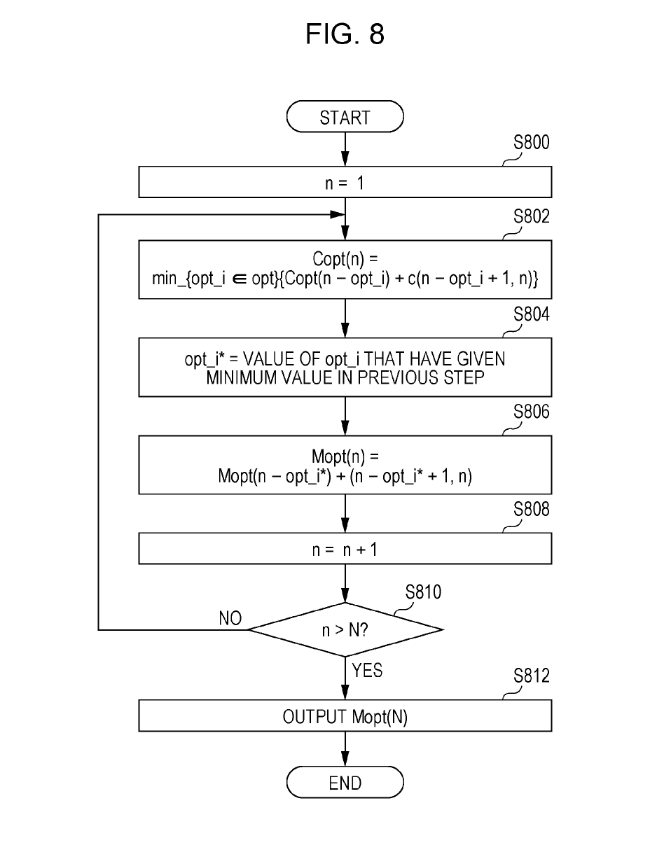

Any given value can be adopted as the merge unit. However, as a value adopted as the merge unit becomes larger, the possibility of part of a long label not being displayed and being hidden increases as illustrated in FIG. 4D. Accordingly, in embodiments of the present invention, an optimum combination (or also referred to as an array) of merge units for all items included in a list box is determined by solving a cost minimization problem where a length of hidden parts is associated with cost in dynamic programming and the merge unit is associated with an option in dynamic programming. Details about the determination method will be described later with reference to FIG. 8. Embodiments of the present invention will be described below assuming that a plurality of items are arranged vertically in the interaction area and the individual items are horizontally long. However, a person skilled in the art would easily understand that embodiments of the present invention are similarly applicable to the case where a plurality of items is arranged horizontally in the interaction area and the individual items are vertically long.

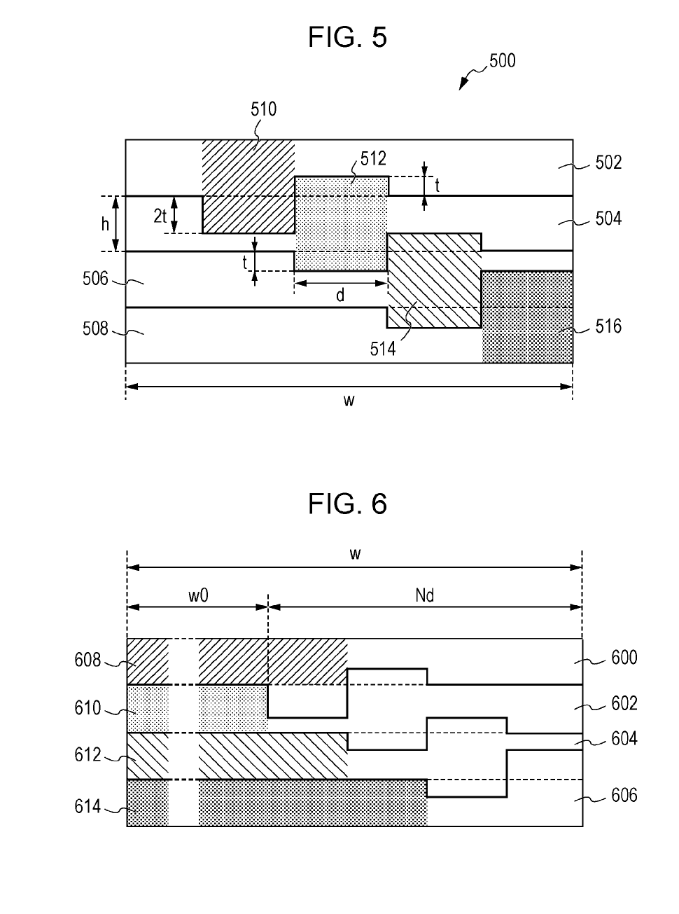

Prior to a detailed description of embodiments of the present invention, meanings of symbols used herein will be described with reference to FIGS. 5 and 6 as preparation.

FIG. 5 illustrates a plurality of user-selectable items 502 to 508 which are arranged vertically in an interaction area 500. As illustrated in FIG. 5, a symbol h represents a height of each item and a symbol w represents a width of each item. Also, a symbol t represents a height of an area that is expanded to protrude into the neighboring item in accordance with embodiments of the present invention, and a symbol d represents a width of the expanded area. In the case where an item has two neighboring items (such as the item 504 having two neighboring items 502 and 506), the item is expanded by the height t toward each of the neighboring items. On the other hand, in the case where an item has only one neighboring item (such as the item 502 having only one neighboring item 504), the item is expanded by a height 2t toward the one neighboring item. Each expanded area makes it easier for the user to select the corresponding item. Hereinafter, the symbols t and d and hatched rectangular areas 510 to 516 are respectively referred to as a selection-area expanded height, a selection-area expanded width, and selection areas of the items.

FIG. 6 illustrates label display areas 608 to 614 of the items 600 to 606, respectively. Here, a label display area refers to an area of an item in which a label can be displayed. Originally, the entire width w of the item can be used for displaying a label. However, in embodiments of the present invention, each of N (here, N is a positive integer representing the merge unit) neighboring items protrudes into a neighboring area to create a selection area. Thus, in embodiments of the present invention, an area having a length of (N×d) or shorter within the item width w can no longer be used for displaying a label (see the item 602). Note that an operator x represents multiplication herein. In the case of N=1, the width of the label display area is equal to w. In the case of N≧2, the widths of the label display areas are, sequentially from the top item, w0+d, w0, w0+d, . . . , w0+(N−2)×d, where w0=w−N×d. In the example illustrated in FIG. 6, the selection areas are shifted from one another from left to right sequentially from the top item. However, it is obvious that the selection areas may be shifted from one another from left to right sequentially from the bottom item conversely. In this case, the widths of the label display areas are, sequentially from the bottom item, w0+d, w0, w0+d, . . . , w0+(N−2)×d. The width of the label display area is used for calculating a length of hidden parts of labels, and the length of hidden parts of labels is used when an optimum combination of merge units is determined by solving a cost minimization problem.

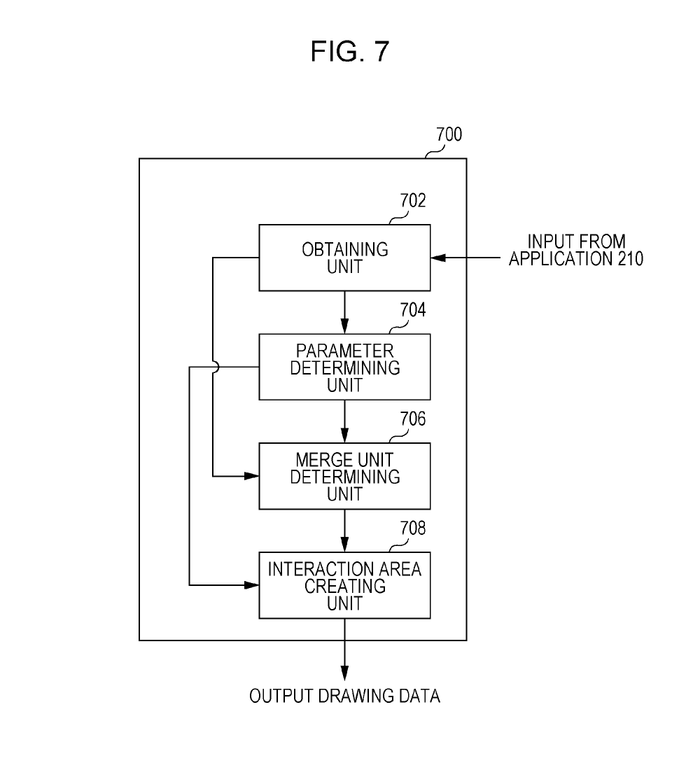

Referring next to FIG. 7, a description will be given of functions of a system 700 for creating an interaction area that lists a plurality of user-selectable items in accordance with the embodiment of the present invention. The system 700 includes an obtaining unit 702, a parameter determining unit 704, a merge unit determining unit 706, and an interaction area creating unit 708.

The obtaining unit 702 obtains, as input from the application 210 that calls the system 700, an array of pieces of label text and the width w and the height h of each item. The obtaining unit 702 then determines an array of label lengths from the obtained array of pieces of label text. Note that, as the width w and the height h of each item, predetermined constant values may be preset by a creator of the library 205.

The parameter determining unit 704 determines the selection-area expanded height t, the selection-area expanded width d, and a maximum value Nₘₐₓ that can be used as the merge unit. To do this, the parameter determining unit 704 first receives the width w and the height h of each item from the obtaining unit 702, and uses the following constants.

Selection-area protrusion ratio: r (0<r<0.5)
Selection-area aspect ratio condition: α (0<α<1)
Label-display-area ratio condition: β (0.5≦β<1)
Not-merged item cost: c (0<c)

Here, each of values within parentheses indicates an example of a settable range of the value of the constant. These constants may be preset by the creator of the library 205. Alternatively, the obtaining unit 702 may receive, from the application 210, values of the constants within the ranges described with the parentheses.

The aforementioned constants will be described in detail. The selection-area protrusion ratio r is a constant that determines an amount of protrusion relative to the height h of each item, that is, a ratio of the selection-area expanded height t to the height h of each item. The selection-area aspect ratio condition α is a constant that defines a condition regarding a ratio of the selection-area expanded width d to the height (h+2t) of the selection area. The label-display-area ratio condition β is a constant that defines a condition regarding a ratio of the shortest label display area width w0 to the width w of each item. Note that w0=w−d×Nₘₐₓ is satisfied. The not-merged item cost c represents a cost to be added to a merger cost (described later) as a penalty in the case where part of the item is not merged and expanded. Because it is preferable that items not to be merged be avoided, a large value is preferably set as the not-merged item cost c.

The parameter determining unit 704 determines the selection-area expanded height t, the selection-area expanded width d, and the maximum usable merge unit Nₘₐₓ so that the following conditions are satisfied.

t=h×r

d≧(h+2t)×α

w0≧w×β

Note that the selection-area expanded width d and the maximum usable merge unit Nₘₐₓ are not uniquely determined with the above conditions alone. The creator of the library 205 may give a predetermined policy as an algorithm so that the parameter determining unit 704 can uniquely determine these values, or may make a configuration so that the creator of the application 210 can set a conditional expression via the obtaining unit 702. Such an algorithm or conditional expression may be, for example, “maximize the selection-area expanded width d under the conditions (so as to make it easier for the user to touch the item)”.

The parameter determining unit 704 also determines a set of options of the number of to-be-merged items (hereinafter, referred to as opt={a set of natural numbers} or simply opt). Note that each option opt_i does not exceed Nₘₐₓ. Patterns of options of the number of to-be-merged items can be classified into any of the following three categories.

The number of to-be-merged items is always constant
Example: opt={3}, meaning that items are merged always in units of three

The number of to-be-merged items is selected from some options
Example: opt={2, 3}, meaning that items are merged in units of two or three

The presence of not-to-be-merged items is permitted
Example: opt={1, 2, 3}, meaning that items are not merged or items are merged either in units of two or three

The creator of the library 205 in advance gives a policy used when opt is automatically determined. For example, the creator of the library 205 may give Expression opt={Nₘₐₓ −1, Nₘₐₓ} as an algorithm in advance. Alternatively, the obtaining unit 702 may receive information regarding opt from the application 210.

The merge unit determining unit 706 receives the selection-area expanded width d and opt from the parameter determining unit 704 and the array of label lengths from the obtaining unit 702. By using these pieces of information, the merge unit determining unit 706 determines, for each item in the interaction area, an optimum merge unit from among the options included in opt. As described above, an optimum combination of merge units for all items included in the interaction area is determined by solving a cost minimization problem where a length of the parts of labels that are hidden due to merger of a plurality of neighboring items is associated with cost in dynamic programming and the merge unit is associated with an option in dynamic programming. In the case where opt includes only one option, the merge unit determining unit 706 just outputs the one option.

In one example, the merge unit determining unit 706 can use, as a cost for the option opt_i included in opt, a sum of lengths of the parts of the labels that are hidden at individual opt_i items due to merger of the opt_i items. Then, the merge unit determining unit 706 may use, as a merger cost for the interaction area, a sum of the costs of merger in the interaction area, and determine a combination (array) of merge units that minimizes the merger cost. Details about the process performed by the merge unit determining unit 706 will be described later with reference to FIG. 8.

As described above, it is preferable that items not to be merged be avoided if possible. Thus, in the case of opt_i=1, a large value is preferably substituted into the cost. The merge unit determining unit 706 receives such a not-merged item cost c from the parameter determining unit 706. Also, in the case where there is no selectable option for an item located at a last part of the interaction area, the merge unit determining unit 706 may select a value that is smaller than the options included in opt (rule 1). In such a case, a value serving as the penalty may be added to the merger cost. Further, in the case where a predetermined number of different values or more are selected as the merge unit, the merge unit determining unit 706 may add a value serving as the penalty to the merger cost (rule 2).

The interaction area creating unit 708 obtains the array of merge units determined by the merge unit determining unit 706 and the selection-area expanded height t and the selection-area expanded width d determined by the parameter determining unit 704, and creates drawing data of the interaction area that lists a plurality of items vertically. At this time, in accordance with the obtained array of merge units, the interaction area creating unit 708 creates drawing data of the interaction area such that each of neighboring items in the merge unit partially protrudes into horizontally long areas of the other items.

The interaction area creating unit 708 stores the created drawing data of the interaction area in a predetermined storage area. The OS 200 or a GUI framework of the OS 200 reads the drawing data of a visible area from the predetermined storage area in response to a user operation, and causes the visible area to be displayed on the screen of the display device 116.

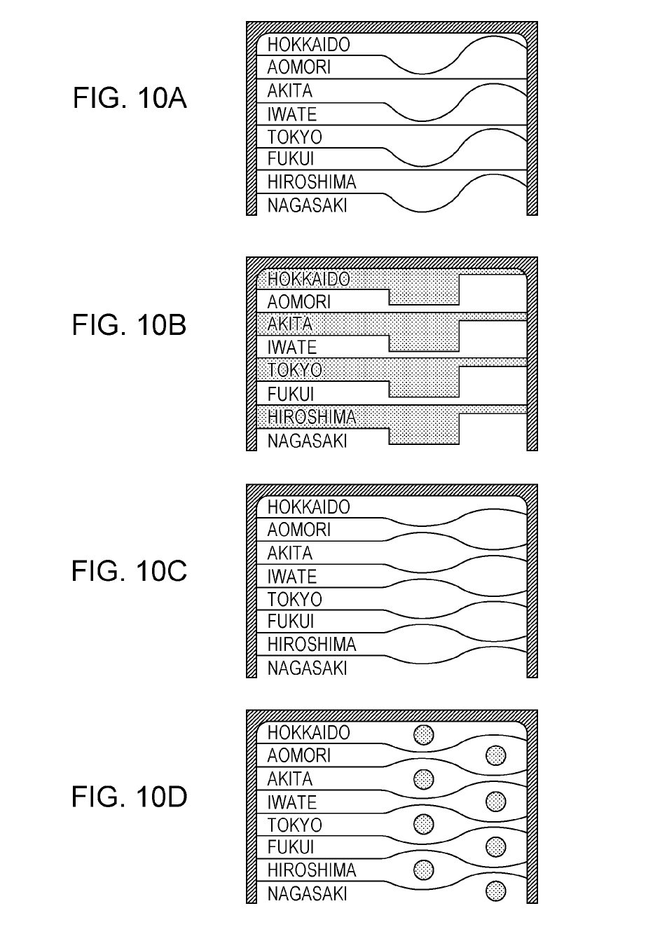

Referring now to FIGS. 10A to 10D, screen display examples of the list box according to embodiments of the present invention will be described. As illustrated in FIGS. 10A and 10C, the interaction area creating unit 708 may form a boundary of the protruding parts of individual items in the interaction area as a curve. Alternatively, as illustrated in FIGS. 10B and 10D, the interaction area creating unit 708 may make the background of neighboring items in the interaction area different from each other, or make the background at the protruding position of each item different from the background of the other area of the item.

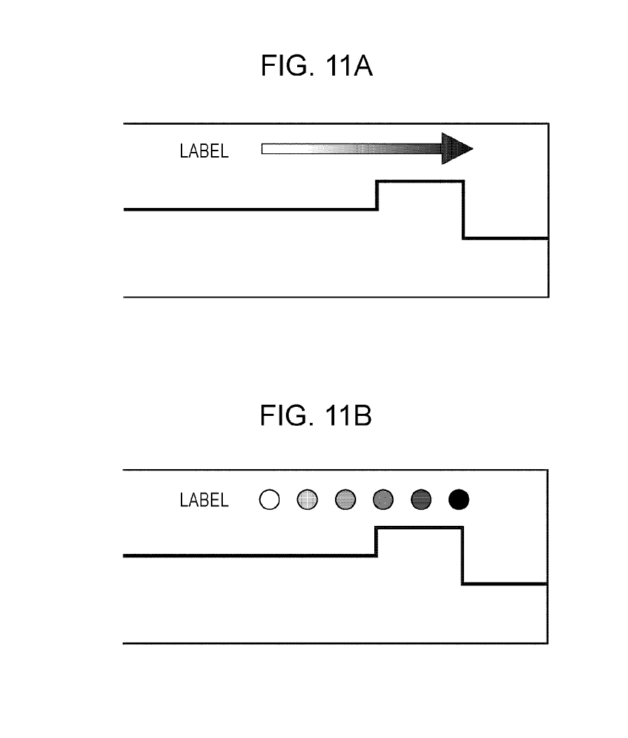

Referring next to FIGS. 11A and 11B, examples of an indicator displayed along with the list box according to embodiments of the present invention will be described. The indicator is displayed in order to make it easier to recognize that there is a selection area in each item, and animation may be used within the interaction area. For example, as illustrated in FIG. 11A, the interaction area creating unit 708 may further create drawing data of animation in which gradation moves from left to right within an arrow. Alternatively, as illustrated in FIG. 11B, the interaction area creating unit 708 may further create drawing data of animation in which a figure such as a circle (or only the color of the figure) moves from left to right.

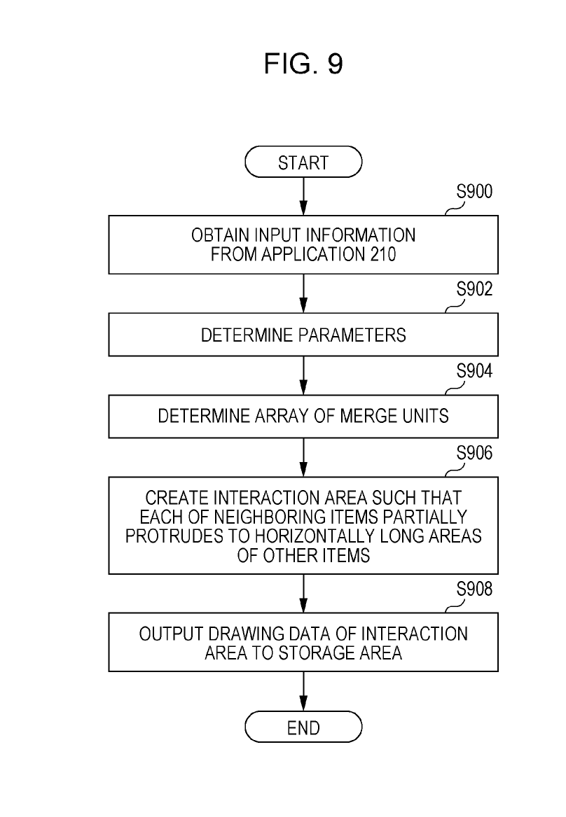

Referring next to FIGS. 8 and 9, an operation performed by the system 700 that creates user selectable items in accordance with the embodiment of the present invention will be described.

FIG. 8 is a flowchart illustrating a flow of an array-of-merge-units determining process performed by the merge unit determining unit 706. As described above, an array of merge units is determined by using dynamic programming in this embodiment. In order to determine an optimum array of merge units for an interaction area including N items, “the optimum solution of the array of merge units for n items from the start of the interaction area” may be sequentially determined by changing n from n=1 to n=N.

Before starting the array-of-merge-units determining process, the merge unit determining unit 706 obtains, as input, the maximum merge unit value Nₘₐₓ (Nₘₐₓ ≦N), the set of options of the number of to-be-merged items opt, and a merger cost function c. It is assumed here that opt=[opt_{—}1, . . . , opt_L] and the number of elements of opt is L (L≧1). Each opt_i satisfies 1≦opt_i≦Nₘₐₓ, and values do not coincide with one another. Also, the cost of merger of an i-th item to a j-th item is expressed as c(i, j) (where, 1≦i≦j≦Nₘₐₓ). The value of c(i, j) may be calculated each time in S802 described later. The cost can be a sum of lengths of the parts of the labels hidden in the individual items from the i-th item to the j-th item as described above. The length of the part of the label hidden in each item can be determined by subtracting the length (width) of the label display area of the item from the length of the label of the item determined by the obtaining unit 702. The length (width) of the label display area of each item is as described with reference to FIG. 6.

In the course of determining the array of merge units, the merge unit determining unit 706 also determines, as interim results, the minimum merger cost Copt(n) for the first item to the n-th item and a merger method Mopt(n) which gives the minimum merger cost Copt(n) for the first item to the n-th item, where 1≦n≦N. Also, Mopt(n) is an array of M elements, and is in a format of [(i_{—}1, j_{—}1), (i_{—}2, j_{—}2), . . . , (i_M, j_M)]. A k-th (1≦k≦M) element (i_k, j_k) of the array indicates that items from an i_k-th item to a j_k-th item are merged. Here, i_{—}1=1 and j_M=n; i_k j_k for each k; and i_k′+1=j_(k′+1) for each k′ (1≦k′≦M−1). These are conditions for arranging the numerical values of the elements of the array in ascending order.

What is ultimately output by the merge unit determining unit 706 is the value of Mopt when n=N, that is, the merger method Mopt(N) that gives the minimum merger cost of items from the first item to the N-th item. The following describes the array-of-merge-units determining process in accordance with the flowchart illustrated in FIG. 8.

The process illustrated in the flowchart of FIG. 8 starts from S800, in which the merge unit determining unit 706 sets 1 in n. Then, the merge unit determining unit 706 searches for an option that minimizes the value of Expression Copt(n−opt_i)+c(n−opt_{—}1+1, n) from among options opt_i of the number of to-be-merged items, and sets the minimum value in Copt(n) (S802) and sets the option that gives the minimum value in opt_i* (S804).

Then, the merge unit determining unit 706 sets the value of Expression Mopt(n−opt_i*)+(n−opt_i*+1, n) in the array Mopt(n) (S806). Then, the merge unit determining unit 706 adds 1 to the value of n (S808), and determines whether or not Expression n>N is satisfied (S810). If it is determined Expression is satisfied (YES in S810), the process proceeds to S812, in which the merge unit determining unit 706 outputs Mopt(N). On the other hand, if it is determined that Expression is not satisfied (NO in S810), the process returns to S802 and the merge unit determining unit 706 repeats the series of processing operations.

The following describes pseudo-code of the process performed by the merge unit determining unit 706.

```
import java.util.ArrayList;
import java.util.List;
public class MergeCalculator {
  // type of a pair
  public class Pair {
```

```
public int i;
public int j;
public Pair(int i, int j) {
  this.i = i;
  this.j = j;
}
```

```
  }
  // type of a cost function
  private interface CostFunc {
```

public int apply(int i, int j);

```
  }
  public List<Pair> compute(int N, int Nmax, List<Integer>
  opt, CostFunc c) {
```

```
List<List<Pair>> Mopt = new ArrayList<List<Pair>>( );
List<Integer> Copt = new ArrayList<Integer>( );
for (int n = 1; n <= N; n++) { // 1. in the flowchart
  int minCost = Integer.MAX_VALUE;
  int opti_star = 0; // opti*
  for (int opti : opt) { // 2-a.
```

```
int cost = Copt.get(n − opti) + c.apply(n −
opti + 1, n);
if (cost < minCost) {
  minCost = cost;
  opti_star = opti; // 2-b.
}
```

```
  }
  // 2-c.
  List<Pair> Moptn = new ArrayList<Pair>(Mopt.get(n −
  opti_star));
  Moptn.add(new Pair(n − opti_star + 1, n));
  Mopt.set(n, Moptn);
}
return Mopt.get(N);
```

}
}

Now, the array of merge units is determined specifically using a list box including five rows as example. The cost c(i,j) for merging items from the i-th item to the j-th item is calculated as follows: c(1,2)=c(4,5)=20; c(2,3)=25; c(3,4)=30; c(3,5)=40; c(1,3)=50; and c(i,i)=100.

### Example 1

### Case where the Number of to-be-Merged Items is Fixed to Two, i.e., Opt={2}

The merger method is uniquely determined, and there is only a pattern of two rows, two rows, and one row. The rule 1 is applied to the last row (the cost=20+30+100=150).

### Example 2

### Case where the Number of to-be-Merged Items is Selected from Two and Three, i.e., Opt={2, 3}

According to dynamic programming, the cost is minimized when merger is performed in a pattern of two rows and three rows (20+40=60<70=50+20). Note that merger in a pattern of two rows, two rows, and one row is also possible based on the rule 1. However, the cost becomes larger (150). From the same reason, a pattern of three rows, one row, and one row is also excluded (250).

### Example 3

### Case where the Number of to-be-Merged Items is Basically Two Rows but a Row not to be Merged is Permitted, i.e., Opt={1, 2}

According to dynamic programming, the merger cost of a pattern of two rows, one row, two rows is the minimum (the cost=20+100+20=140).

FIG. 9 is a flowchart illustrating an example of a flow of a process for creating user selectable items in accordance with the embodiment of the present invention. The user-selectable item creation process illustrated in FIG. 9 starts from S900, in which the obtaining unit 702 obtains input information, such as an array of pieces of label text, from the application 210. The obtaining unit 702 calculates an array of label lengths from the obtained array of pieces of label text. Then, the parameter determining unit 704 determines the selection-area expanded height t, the selection-area expanded width d, the maximum usable merge unit value Nₘₐₓ, and further the set of options of the merge unit opt, by using the width w and height h of each item and the plurality of predetermined constants (S902).

Then, the merge unit determining unit 706 receives the selection-area expanded width d and opt from the parameter determining unit 704 and the array of label lengths from the obtaining unit 702, and determines, by using these pieces of information, the optimum merge unit for each item in the interaction area from among options included in opt (S904). The array-of-merge-units determining process performed by the merge unit determining unit 706 is as described in detail with reference to FIG. 8.

Then, the interaction area creating unit 708 creates drawing data of the interaction area such that each of neighboring items which are at least some items among the plurality of items partially protrudes into a horizontally long area of the other item (S906). At this time, the interaction area creating unit 708 sequentially extracts values from the array of merge units determined by the merge unit determining unit 706, and merges the number of items indicated by each value so as to partially expand an area of each item.

Then, the interaction area creating unit 708 stores the created drawing data of the interaction area in a predetermined storage area (S908). The OS 200 or a GUI framework of the OS 200 reads the drawing data of a visible area from the predetermined storage area in response to a user operation, and causes the visible area to be displayed on the screen of the display device 116. The process then ends.

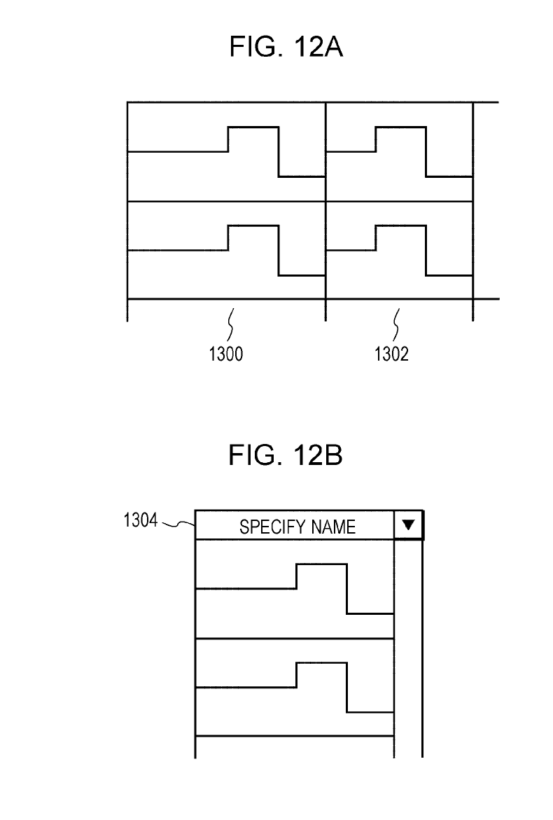

While embodiments of the present invention have been described above using the embodiment, the technical scope of the present invention is not limited to the scope described in the embodiment. It is obvious to a person skilled in the art that various modifications and improvements can be added to the embodiment. For example, the case where horizontal writing is performed from left to right such as in Japanese and English has been described by way of example above. However, in the case where the writing direction is from right to left, an empty space is created on the left side of items, and thus boundaries of the individual items are expanded so that selection areas are provided on the left side. Also, an object to which the present invention is applied is not limited to a list box, and the present invention can be applied to other objects, such as a table and a combo box as illustrated in FIGS. 12A and 12B, as long as the objects are interaction areas that list a plurality of user-selectable items. Note that in a table, cells of each column are merged. Accordingly, such a modification or improvement is obviously within the technical scope of the present invention.

It should be noted that, regarding the execution order of processes such as operations, procedures, steps, and stages in apparatuses, systems, programs, and methods described in the claims, the description, and the drawings, expressions such as “before” and “prior to” are not explicitly given, and the apparatuses, the systems, the programs, and the methods can be implemented in any order unless the output of a preceding process is used in a following process. It should also be noted that, even when the output of the preceding process is used in the following process, another process may be inserted between the preceding process and the following process or that, even when the description is given such that another process may be inserted between the preceding process and the following process, the configuration can also be changed so that the preceding process is performed immediately before the following process. Even when operation flows in the claims, the description, and the drawings are described using expressions such as “first”, “next”, and “subsequently” for convenience, this does not necessarily mean that such order is required.

1. A computer implemented method for creating an interaction area that lists a plurality of user-selectable items, the method comprising:
creating, by the computer, drawing data of the interaction area such that each of neighboring items which are at least some items among the plurality of items partially protrudes into an area of the other item; and
outputting, by the computer, the created drawing data of the interaction area.

2. The method of claim 1, wherein the plurality of items are arranged vertically in the interaction area and each item is horizontally long, or the plurality of items are arranged horizontally in the interaction area and each item is vertically long.

3. The method of claim 2, wherein the number of neighboring items is determined as a merge unit from among a plurality of candidates.

4. The method of claim 3, wherein a combination of the merge units for all the items in the interaction area is determined by solving a cost minimization problem where a length of the parts of the labels of items hidden by protruding parts of neighboring items is associated with cost in dynamic programming and the merge unit is associated with an option in dynamic programming.

5. The method of claim 4, wherein the plurality of candidates include 1, and in a case where 1 is selected as the merge unit, a value serving as a penalty is added to the cost.

6. The method of claim 4, wherein in a case where a predetermined number of different candidates or more are selected as the merge unit from among the plurality of candidates, a value serving as a penalty is added to the cost.

7. The method of claim 4, wherein on condition that the plurality of candidates includes no value selectable as the merge unit, a value smaller than the plurality of candidates is selected.

8. The method of claim 1, wherein a plurality of values are adopted as the number of neighboring items for the interaction area.

9. The method of claim 1, wherein the interaction area is a list box.

10. The method of claim 1, wherein the interaction area is a combo box.

11. The method of claim 1, wherein the interaction area is a table.

12. The method of claim 1, wherein a boundary of protruding parts of the items is formed as a curve by the computer.

13. The method of claim 1, wherein a background of the items listed in the interaction area is made different between the neighboring items by the computer.

14. The method of claim 1, wherein a background at a protruding position of each of the items listed in the interaction area is made different from a background of the other area of the item by the computer.

15. The method of claim 1, wherein drawing data of an indicator which uses animation for guiding a line of sight to protruding positions of the individual items is created by the computer, and the drawing data of the indicator is output by the computer.

16. The method of claim 1, wherein the computer has a touchscreen.

17. The method of claim 1, wherein the computer is a tablet computer, a notebook computer, a smartphone, or a personal digital assistant (PDA).
